(19) United States
(12) Patent Application Publication
(10) Pub. No.: US 2026/0261040 A1
(43) Pub. Date: Sep. 3, 2026

(54) POWER DIVIDER, FEED NETWORK, AND ANTENNA SYSTEM

(71) Applicant: HUAWEI TECHNOLOGIES CO., LTD., Shenzhen (CN)

(72) Inventors: Chaochao Li, Xi'an (CN); Li Jin, Xi'an (CN); Weihong Xiao, Dongguan (CN); Qiqiang Gao, Dongguan (CN); Hao Qi, Xi'an (CN)

(73) Assignee: HUAWEI TECHNOLOGIES CO., LTD., Shenzhen (CN)

(21) Appl. No.: 19/659,352

(22) Filed: Apr. 27, 2026

Related U.S. Application Data
(63) Continuation of application No. PCT/CN2024/124882, filed on Oct. 15, 2024.

(30) Foreign Application Priority Data
Oct. 31, 2023 (CN) 202311444272.6

(51) Int. Cl. H01Q 1/50; H01P 3/08

(52) U.S. Cl. CPC H01Q 1/50; H01P 3/08

(57) ABSTRACT

This application provides example power dividers. One example power divider includes a metal ground plane and a metal strip line. The metal strip line is disposed on a side of the metal ground plane in a direction perpendicular to the metal ground plane. The metal strip line includes a power division node, an input port, a first output port, and a second output port. The metal strip line between the power division node and the first output port is a first output line, the metal strip line between the power division node and the second output port is a second output line, and the two output lines respectively include a first node and a second node. Impedances of the metal strip line on two sides of the first node are different, and impedances of the metal strip line on two sides of the second node are different.

### CROSS-REFERENCE TO RELATED APPLICATIONS

This application is a continuation of International Application No. PCT/CN2024/124882, filed on Oct. 15, 2024, which claims priority to Chinese Patent Application No. 202311444272.6, filed on Oct. 31, 2023. The disclosures of the aforementioned applications are incorporated herein by reference in their entireties.

### TECHNICAL FIELD

This application relates to the field of wireless technologies, and specifically, to a power divider, a feed network, and an antenna system.

### BACKGROUND

A feed network is a core component of a base station antenna. The feed network adjusts a downtilt of an antenna beam by changing a phase of a radiating element. A standing wave level and a tolerance level of the feed network affect a standing wave level of the antenna, and the standing wave level of the antenna is an important factor that affects stability and reliability of antenna performance.

A power divider is an important part of the feed network, and there are mainly two types of dividers among existing power dividers: T-junction power dividers and Wilkinson power dividers. For the T-junction power dividers, their processing precision easily causes changes of standing waves, leading to fluctuations in standing waves of the feed network and the antenna. For the Wilkinson power dividers, they use a resistor to connect two output lines, where the resistor can absorb reflected standing waves. However, when input power of the Wilkinson power divider is high, the resistor is prone to burn out, which degrades the ability of the resistor to absorb standing waves.

Therefore, there is a need to provide a power divider to reduce standing waves in the feed network and the antenna.

### SUMMARY

This application provides a power divider, a feed network, and an antenna system, to reduce standing waves in the power divider, the feed network, and the antenna system.

According to a first aspect, a power divider is provided, used in an antenna system. The power divider includes a metal ground plane and a metal strip line. The metal strip line is disposed on a side of the metal ground plane in a direction perpendicular to the metal ground plane, the metal strip line includes a power division node, an input port, a first output port, and a second output port, and the power division node is configured to separately transmit, to the first output port and the second output port, a signal input from the input port. The metal strip line between the power division node and the first output port is a first output line, the first output line includes a first node, and impedances of the metal strip line on two sides of the first node are different. The metal strip line between the power division node and the second output port is a second output line, the second output line includes a second node, and impedances of the metal strip line on two sides of the second node are different. A difference between a length of the metal strip line between the power division node and the first node and a length of the metal strip line between the power division node and the second node is an integer multiple of a quarter of an operating wavelength of the antenna system.

In this embodiment provided in this application, the impedances of the metal strip line on two sides of the first node on the first output line are different, the impedances of the metal strip line on two sides of the second node on the second output line are different, and the difference between the length of the metal strip line between the power division node and the first node and the length of the metal strip line between the power division node and the second node is an integer multiple of a quarter of the operating wavelength, so that a phase difference between reflected standing waves in the first output line and the second output line is 180°. This implements cancellation of reflected standing waves in the power divider, a feed network, and the antenna system, improves a standing wave tolerance level of the power divider, the feed network, and the antenna system, and improves performance of the power divider, the feed network, and the antenna system.

With reference to the first aspect, in some implementations of the first aspect, widths of the metal strip line on two sides of the first node are different, and/or widths of the metal strip line on two sides of the second node are different.

In this embodiment provided in this application, the widths of the metal strip line on two sides of the first node are set to be different, and/or the widths of the metal strip line on two sides of the second node are set to be different, so that phases of a reflected standing waves on the metal strip line can be adjusted, to implement cancellation of reflected standing waves.

With reference to the first aspect, in some implementations of the first aspect, a width of the metal strip line between the first node and the second node is greater than both a width of the metal strip line between the first node and the first output port and a width of the metal strip line between the second node and the second output port; or the width of the metal strip line between the first node and the second node is less than both the width of the metal strip line between the first node and the first output port and the width of the metal strip line between the second node and the second output port.

In this embodiment provided in this application, the width of the metal strip line between the first node and the second node is greater than or less than both the width of the metal strip line between the first node and the first output port and the width of the metal strip line between the second node and the second output port, so that phases of reflected standing waves on the metal strip line can be adjusted, to implement cancellation of reflected standing waves, and processing complexity of the power divider can be reduced.

With reference to the first aspect, in some implementations of the first aspect, the power divider further includes a first dielectric, the first dielectric is at least partially disposed between the metal strip line and the metal ground plane, and the metal strip line is at least partially carried on the first dielectric.

In this embodiment provided in this application, the first dielectric is disposed between the metal strip line and the metal ground plane, to support the metal strip line. The metal strip line is at least partially carried on the first dielectric, so that distribution of the first dielectric can further change across different areas on the metal strip line. In this way, areas with different impedances exist on the first output line and the second output line, a phase difference between reflected standing waves on the metal strip line can be adjusted, to implement cancellation of reflected standing waves.

With reference to the first aspect, in some implementations of the first aspect, in the first output line, the metal strip line on one side of the first node is carried on the first dielectric, and the metal strip line on the other side of the first node is not carried on the first dielectric; and/or in the second output line, the metal strip line on one side of the second node is carried on the first dielectric, and the metal strip line on the other side of the second node is not carried on the first dielectric.

In this embodiment provided in this application, distribution of the first dielectric on two sides of the first node and/or the second node changes, so that the impedances of the metal strip line on two sides of the first node and/or the second node change, and phases of reflected standing waves on the metal strip line can be adjusted, to implement cancellation of reflected standing waves.

With reference to the first aspect, in some implementations of the first aspect, the first dielectric is strip-shaped, and the first dielectric is movable in a direction connecting the first node and the second node.

In this embodiment provided in this application, the first dielectric is strip-shaped, and the first dielectric is movable in the direction connecting the first node and the second node, so that not only cancellation of reflected standing waves can be implemented, but also a phase can be adjusted.

With reference to the first aspect, in some implementations of the first aspect, the first dielectric includes a first recess; in the first output line, the metal strip line on one side of the first node is carried on the first dielectric, and the metal strip line on the other side of the first node is disposed above the first recess; and/or in the second output line, the metal strip line on one side of the second node is carried on the first dielectric, and the metal strip line on the other side of the second node is located above the first recess.

With reference to the first aspect, in some implementations of the first aspect, the first dielectric includes a first area and a second area, and a size of the first area in the direction perpendicular to the metal ground plane is greater than a size of the second area in the direction perpendicular to the metal ground plane. In the first output line, the metal strip line on one side of the first node is carried on the first area, and a gap exists between the metal strip line on the other side of the first node and the second area; and/or in the second output line, the metal strip line on one side of the second node is carried on the first area, and a gap exists between the metal strip line on the other side of the second node and the second area.

In this embodiment provided in this application, the first dielectric includes the first recess, or the first dielectric includes the first area and the second area, so that the power divider can adapt to different product forms and implement cancellation of standing waves.

With reference to the first aspect, in some implementations of the first aspect, the power divider further includes a third output port, the metal strip line between the power division node and the third output port is a third output line, and impedances of points on the third output line are the same.

In this embodiment provided in this application, when the power divider includes three output ports, standing wave cancellation on the entire power divider can be implemented only by providing nodes at which impedances change discontinuously on the first output line and the second output line, or by providing nodes at which impedances change discontinuously on any two output lines, without providing nodes at which impedances change discontinuously on the third output line. This can simplify a structure of the power divider and reduce processing complexity.

With reference to the first aspect, in some implementations of the first aspect, the power divider further includes a third output port, the metal strip line between the power division node and the third output port is a third output line, the third output line includes a third node, and impedances of the metal strip line on two sides of the third node are different. A difference between a length of the metal strip line between the power division node and the third node and the length of the metal strip line between the power division node and the first node is an integer multiple of a quarter of the operating wavelength of the antenna system; or a difference between the length of the metal strip line between the power division node and the third node and the length of the metal strip line between the power division node and the second node is an integer multiple of a quarter of the operating wavelength of the antenna system.

With reference to the first aspect, in some implementations of the first aspect, in the third output line, the metal strip line on one side of the third node is carried on the first dielectric, and the metal strip line on the other side of the third node is not carried on the first dielectric.

With reference to the first aspect, in some implementations of the first aspect, widths of the metal strip line on two sides of the third node are different.

In this embodiment provided in this application, when the power divider includes three output ports, nodes at which impedances change discontinuously may be provided on all of the three output lines, so that nodes at which impedances change discontinuously exist on any two of the output lines, and the length difference requirement for the metal strip line is satisfied. This can improve flexibility of setting a structure of the power divider, so that the power divider can adapt to different product forms.

With reference to the first aspect, in some implementations of the first aspect, the power divider further includes a first power division part and/or a second power division part, the first power division part is connected to the first output port, the first output port is an input port of the first power division part, the second power division part is connected to the second output port, and the second output port is an input port of the second power division part.

With reference to the first aspect, in some implementations of the first aspect, impedances in all positions of the first power division part are the same, and/or impedances in all positions of the second power division part are the same.

In this embodiment provided in this application, the first output port and the second output port of the power divider are respectively connected to the first power division part and the second power division part. When the power divider has a complex structure, for example, when the power divider is in a one-to-four structure form, nodes at which impedances change discontinuously need to be provided only on lines on which the two output ports of the power divider are located, to implement cancellation of standing waves on the entire power divider. There is no need to provide nodes at which impedances change discontinuously on the first power division part and the second power division part, so that a structure of the power divider can be simplified, and processing complexity can be reduced.

With reference to the first aspect, in some implementations of the first aspect, the power divider includes a metal cavity, the metal cavity encloses accommodation space, the metal strip line and the first dielectric are disposed in the accommodation space, and the metal ground plane is a part that is of the metal cavity and that is stacked with the metal strip line.

With reference to the first aspect, in some implementations of the first aspect, there are at least two first dielectrics, and the at least two first dielectrics are respectively disposed on two sides of the metal strip line in a direction perpendicular to the metal strip line.

In this embodiment provided in this application, the power divider includes the metal cavity, and the metal strip line, the first dielectrics, and the support dielectric are disposed in the metal cavity, so that the power divider can adapt to different product forms.

With reference to the first aspect, in some implementations of the first aspect, the metal strip line is a printed circuit board structure, or the metal strip line is a sheet metal strip line fastened by a plastic dielectric.

According to a second aspect, a feed network is provided. The feed network includes the power divider according to any one of the first aspect or the implementations of the first aspect.

According to a third aspect, an antenna system is provided. The antenna system includes the feed network according to any one of the first aspect or the implementations of the first aspect and one or more antenna elements, and the feed network is connected to the antenna elements.

### BRIEF DESCRIPTION OF DRAWINGS

FIG. 1 is a diagram of a system architecture according to an embodiment of this application;

FIG. 2 is a diagram of an internal structure of an antenna system according to an embodiment of this application;

FIG. 3 is a diagram of a structure of a power divider according to an embodiment of this application;

FIG. 4 is a diagram of a structure of a power divider according to an embodiment of this application;

FIG. 5 is a diagram of a structure of a power divider according to an embodiment of this application;

FIG. 6 is a diagram of a structure of a power divider according to an embodiment of this application;

FIG. 7 is a diagram of a structure of a power divider according to an embodiment of this application;

FIG. 8 is a diagram of a structure of a power divider according to an embodiment of this application;

FIG. 9 is a diagram of a structure of a power divider according to an embodiment of this application;

FIG. 10 is a diagram of a structure of a power divider according to an embodiment of this application;

FIG. 11 is a diagram of a structure of a power divider according to an embodiment of this application;

FIG. 12 is a diagram of a structure of a power divider according to an embodiment of this application;

FIG. 13 is a diagram of a structure of a power divider according to an embodiment of this application;

FIG. 14 is a diagram of a structure of a power divider according to an embodiment of this application;

FIG. 15 is a diagram of a structure of a power divider according to an embodiment of this application; and

FIG. 16 is a diagram of a structure of a power divider according to an embodiment of this application.

### DESCRIPTION OF EMBODIMENTS

The following describes technical solutions of this application with reference to accompanying drawings.

Reference to “an embodiment”, “some embodiments”, or the like described in this specification indicates that one or more embodiments of this application include a specific feature, structure, or characteristic described with reference to embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner.

The terms “include”, “have”, and their variants all mean “include but are not limited to”, unless otherwise specifically emphasized in another manner.

In embodiments of this application, “first”, “second”, and the like are merely intended to indicate that a plurality of objects are different. For example, a first output port and a second output port are merely used to represent different output ports. The terms should impose no impact on the output ports and a quantity thereof. “First”, “second”, and the like described above should not impose any limitation on embodiments of this application.

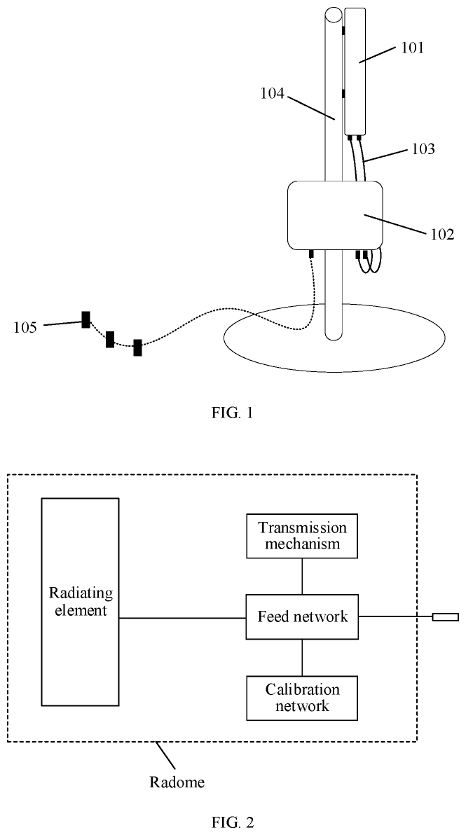

FIG. 1 is a diagram of an architecture of a base station antenna system according to an embodiment of this application. The base station antenna system may include components such as an antenna 101, a feeder 103, a pole 104, a remote radio system (remote radio unit, RRU) 102, and a grounding apparatus 105. The antenna 101 may be fastened to the pole 104 through an adjustable support, and may be connected to the RRU 102 through the feeder 103, and transmit signals between the antenna 101 and the RRU 102 through the feeder 103. The antenna 101 may be further connected to the grounding apparatus 105.

In addition, the antenna 101 may also be integrated with the remote radio unit 112. For example, the antenna 101 and the remote radio unit 102 are a part of an active antenna unit (active antenna unit, AAU). Alternatively, the antenna 101 may be a part of a radio unit (radio unit, RU). This is not limited in this application.

FIG. 2 shows main components of an antenna. The antenna may include a radiating element, a feed network, a driving mechanism, a calibration network, a radome, and the like. The driving mechanism may also be referred to as a driving structure, a driving apparatus, a driving part, or the like. This is not limited in this application.

The radiating element is a basic structural unit of the antenna, and is configured to radiate or receive a radio wave. The radiating element may also be referred to as an antenna element, an element, or the like. One antenna may include one or more radiating elements, and frequencies of different radiating elements may be the same or may be different.

The feed network is configured to feed a signal to a radiating element based on a preset amplitude and phase, or send a received signal to a signal processing unit of a base station based on a preset amplitude and phase. The feed network may be connected to the driving mechanism to implement pointing to different radiation beam directions. The feed network may be further connected to the calibration network, to obtain a calibration signal required by the system, so that the feed network can feed a signal to the radiating element or the signal processing unit of the base station based on a preset amplitude and phase. The feed network may generally be formed by an impedance transmission line, and the impedance transmission line may be in a form of a strip line, a microstrip line, a coaxial line, or the like. The feed network may further include a phase shifter, to adjust a radiation direction of an antenna signal. In some cases, the feed network may further include components such as a combiner and a filter.

The radome is a mechanical part used to protect the antenna system from an external environment. The radome also has good electromagnetic wave penetration characteristics. Components such as the radiating element, the driving mechanism, the calibration network, and the feed network may be accommodated in the radome.

The antenna may further include a reflective plate. The reflective plate may also be referred to as a bottom plate, an antenna panel, a metal reflective surface, or the like, and can improve receiving sensitivity of an antenna signal, reflect and aggregate antenna signals on a receiving point, and can block or shield interference effect of another electromagnetic wave in a reverse direction on a received signal. The reflective plate may also be disposed in the radome, the radiating element may be placed on one side of the reflective plate, and the driving mechanism, the calibration network, and the feed network may be located on the other side of the reflective plate.

Standing waves in the antenna are formed by superposing two waves with a same frequency and opposite transmission directions, and one wave is usually a reflected wave of the other wave. When a signal transmitted by the antenna is transmitted to an end of the antenna and is not completely transmitted, the signal is reflected back, and standing waves are formed. As a result, the antenna signal is damaged and cannot be effectively transmitted to a target device. Consequently, antenna radiation efficiency is reduced, and communication quality is affected.

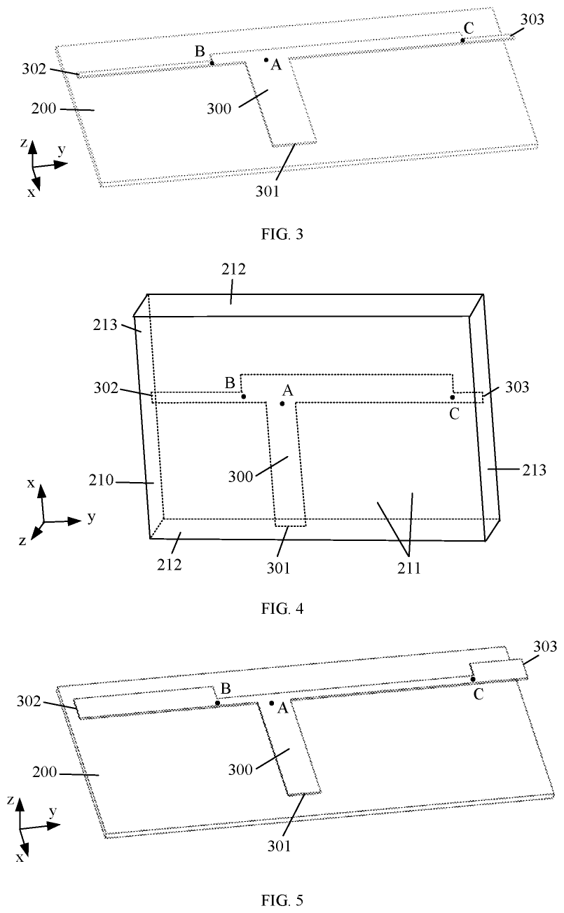

Embodiments of this application provide a power divider, a feed network, and an antenna system, to reduce a standing wave level in the power divider, the feed network, and the antenna system. The power divider may be disposed in the feed network, or may be a part of the feed network. The following first describes in detail a structure of the power divider provided in an embodiment of this application with reference to FIG. 3 to FIG. 15.

As shown in FIG. 3, the power divider may include a metal ground plane 200 and a metal strip line 300. The metal strip line 300 may be disposed on a side of the metal ground plane 200 in a direction perpendicular to the metal ground plane 200, for example, may be disposed on a side of the metal ground plane 200 in a z-axis direction shown in the figure. There may be a gap between the metal strip line 300 and the metal ground plane 200, to avoid a short circuit of the metal strip line 300 caused by a direct electrical connection between the metal strip line 300 and the metal ground plane 200. The metal strip line 300 may include an input port 301 and two output ports (a first output port 302 and a second output port 303). The input port 301, the first output port 302, and the second output port 303 may be respectively located at three ends of the metal strip line 300. The metal strip line 300 may include a power division node A. The power division node A may be located at an intersection of an arm on which the input port 301 of the metal strip line 300 is located, an arm on which the first output port 302 is located, and an arm on which the second output port 303 is located. A signal on the metal strip line 300 may be input by the input port 301, and is divided into two signals by the power division node A, and the two signals are respectively transmitted to the first output port 302 and the second output port 303. According to a reciprocity principle, an input port and an output port may be interchanged. That is, the input port may be used as an output port, and the two output ports may be used as two input ports.

A part that is of the metal strip line 300 and that is located between the power division node A and the first output port 302 may be a first output line, or may be understood as the arm on which the first output port 302 is located. The first output line may include a first node B, and impedances of the metal strip line 300 on two sides of the first node B are different. Two sides of the first node B may be two sides of the first node B along the first output line. For the power divider shown in FIG. 3, the two sides of the first node B may be understood as: A part from the first node B to the power division node A is on one side, and a part from the first node B away from the power division node A is on the other side. A part that is of the metal strip line 300 and that is located between the power division node A and the second output port 303 may be a second output line, or may be understood as the arm on which the second output port 303 is located. The second output line may include a second node C, and impedances of the metal strip line 300 on two sides of the second node C may also be different. Similarly, two sides of the second node C may be two sides of the second node C along the second output line. For the power divider shown in FIG. 3, it may be understood that a part from the second node C to the power division node Ais one side, and a part from the second node C away from the power division node A is on the other side. The first node B and the second node C may also be referred to as discontinuity nodes.

In some implementations, widths of the metal strip line 300 on two sides of the first node B may be different, so that impedances of the metal strip line 300 on two sides of the first node B are different. Widths of the metal strip line 300 on two sides of the second node C may also be different. The widths of the metal strip line 300 on two sides of the first node B may be sizes of the metal strip line 300 on two sides of the first node B in a direction perpendicular to a signal transmission direction. That is, sizes of the metal strip line 300 in an x-axis direction shown in the figure. The widths of the metal strip line 300 on two sides of the second node C are similar.

It should be noted that, for ease of describing a structure of the power divider, positions of the power division node A, the first node B, and the second node C are schematically marked in a form of “points” in the figure. The power division node A, the first node B, and the second node C may actually be areas instead of points. For example, the power division node A may be an area in which a signal is divided on the metal strip line 300, the first node B may be an entire overlapping boundary area in which a width of the metal strip line 300 changes on the first output line, and the second node C may also be an entire overlapping boundary area in which a width changes on the second output line. In an actual product, an overall width of the metal strip line 300 is small, and an area in which a width changes may be approximately considered as a node.

In the power divider shown in FIG. 3, a projection of the second output port 303 in the direction perpendicular to the metal ground plane 200 is located outside an area in which the metal ground plane 200 is located, and a projection of the first output port 302 in the direction perpendicular to the metal ground plane 200 is located inside the area in which the metal ground plane 200 is located. Alternatively, projections of the first output port 302 and the second output port 303 in the direction perpendicular to the metal ground plane 200 may be both located outside the area in which the metal ground plane 200 is located, or may be both located inside the area in which the metal ground plane 200 is located. This is similar for each output port of the power divider described below, and this is not limited in this application.

In some embodiments, a difference between a length of the metal strip line 300 between the power division node A and the first node B and a length of the metal strip line 300 between the power division node A and the second node C may be an integer multiple of a quarter of an operating wavelength of an antenna system. For the metal strip line 300 shown in FIG. 3, the first output line and the second output line are in a straight line as a whole, and the length of the metal strip line 300 between the power division node A and the first node B may be a size of the metal strip line 300 between the power division node A and the first node B in a direction of a y axis shown in the figure. Similarly, the length of the metal strip line 300 between the power division node A and the second node C may be a size of the metal strip line 300 between the power division node A and the second node C in the direction of the y axis shown in the figure.

In this embodiment provided in this application, the difference between the length of the metal strip line 300 between the power division node A and the first node B and the length of the metal strip line 300 between the power division node A and the second node C is an integer multiple of a quarter of the operating wavelength, so that reflected standing waves on the metal strip line 300 can cancel each other, to improve a standing wave tolerance level of the feed network and the antenna system, and improve antenna performance. For example, for an antenna with an operating frequency of 2 gigahertz (GHz), a wavelength of an electromagnetic wave propagated on the metal strip line 300 is 150 millimeters (mm). When the difference between the length of the metal strip line 300 between the power division node A and the first node B and the length of the metal strip line 300 between the power division node A and the second node C is a quarter of the operating wavelength, a phase difference between an electromagnetic wave transmitted in a direction from the power division node A to the first node B on the metal strip line 300 and an electromagnetic wave propagated in a direction from the power division node A to the second node C is 90°. Therefore, a phase difference between reflected electromagnetic waves is 180°, so that the reflected electromagnetic waves cancel each other. That is, reflected standing waves cancel each other.

It should be noted that, in this embodiment of this application, the difference between the length of the metal strip line 300 between the power division node A and the first node B and the length of the metal strip line 300 between the power division node A and the second node C is an integer multiple of a quarter of the operating wavelength. This may mean that the length difference on the metal strip line 300 is approximately an integer multiple of a quarter of the operating wavelength, instead of an absolute numerical requirement. A deviation within a range is allowed for the length difference on the metal strip line 300. For example, the length difference on the metal strip line 300 may alternatively be an integer multiple of 1/4.1 of the operating wavelength. In addition, the length difference on the metal strip line 300 is an integer multiple of a quarter of the operating wavelength. The integer may be a non-zero integer, for example, may be 1, 2, 3, 4, or the like times a quarter of the operating wavelength.

When the first output line and the second output line of the power divider respectively include the first node and the second node, and the first node and the second node are formed because of different widths of the metal strip line, the power divider may further include a first dielectric, and the first dielectric may be disposed between the metal ground plane 200 and the metal strip line 300 (not shown in FIG. 3). When the power divider includes the first dielectric, the first dielectric may cover the entire metal ground plane 200, or the first dielectric may cover a part of an area of the metal ground plane 200. In other words, the metal strip line 300 may be disposed on the first dielectric as a whole, or a part of an area of the metal strip line 300 may be disposed on the first dielectric. The first dielectric may be of a non-metal material, to avoid a short circuit of the metal strip line 300. A position of the first dielectric may be fixed, to support the metal strip line. When the first dielectric is used for support, the first dielectric may also be referred to as a support dielectric. The first dielectric may also move relative to the metal strip line, to implement phase adjustment. When the first dielectric is used for phase adjustment, the first dielectric may also be referred to as a phase-shifting medium.

FIG. 4 is a diagram of an overall structure of another power divider according to an embodiment of this application. The power divider may include a metal cavity 210. The metal cavity 210 may enclose accommodation space. The metal strip line 300 described in FIG. 3 may be disposed in the accommodation space enclosed by the metal cavity 210. For example, the metal cavity 210 may include a ground plane layer 211 and a side wall 212. The side wall 212 may be disposed around a periphery of the ground plane layer 211 to form a cuboid structure. There may be two ground plane layers 211, which are respectively disposed on two sides of the metal strip line 300 in the z-axis direction shown in the figure and are stacked with the metal strip line 300. The metal ground plane 200 is also the ground plane layer 211 of the metal cavity 210. For example, the ground plane layer 211 may be parallel to a main plane of the metal strip line 300, and the main plane of the metal strip line 300 may be an xy plane shown in the figure.

In other words, the power divider may include one layer of metal ground plane 200, or may include two layers of metal ground planes 200. When the power divider includes two layers of metal ground planes 200, the two layers of metal ground planes 200 may be disposed on upper and lower sides of the metal strip line 300 in a direction perpendicular to a main plane of the metal strip line 300, that is, upper and lower sides in the z-axis direction.

When the power divider includes a single-layer metal ground plane 200, the power divider may be used in, for example, a printed circuit board (printed circuit board, PCB). When the power divider includes a double-layer metal ground plane 200, the power divider may be used in a strip line (strip line) structure. Therefore, the power divider can be used in different application scenarios according to an actual use requirement.

In the power dividers shown in FIG. 3 and FIG. 4, a width of the metal strip line 300 between the first node B and the second node C is greater than a width of the metal strip line 300 between the first node B and the first output port 302, and is also greater than a width of the metal strip line 300 between the second node C and the second output port 303. Alternatively, the width of the metal strip line 300 between the first node B and the second node C may be less than the width of the metal strip line 300 between the first node B and the first output port 302, or may be greater than the width of the metal strip line 300 between the second node C and the second output port 303. Refer to a structure of the power divider shown in FIG. 5. Other structural features of the power divider may be similar to the power divider shown in FIG. 3, and details are not described herein again.

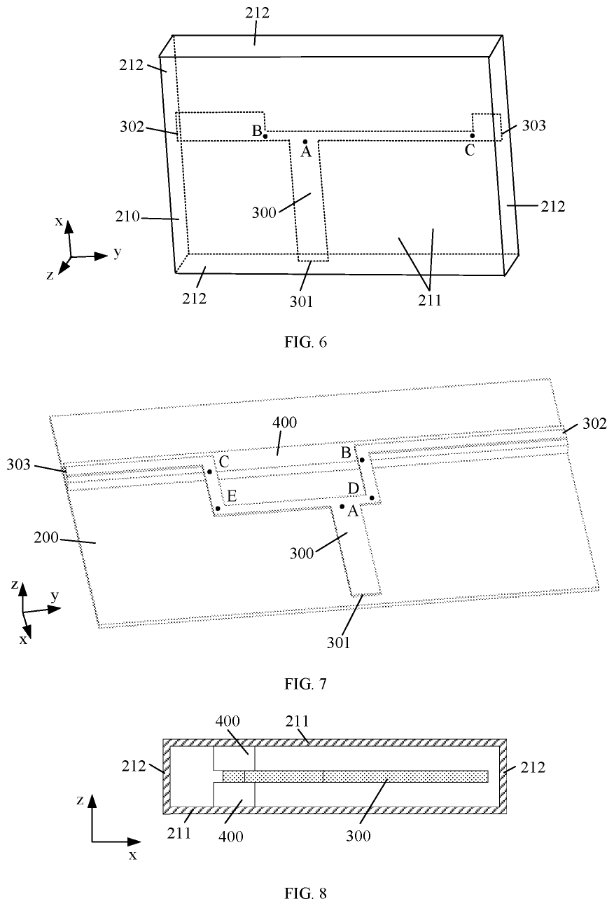

Similar to the structures shown in FIG. 3 and FIG. 4, the metal strip line 300 of the structure shown in FIG. 5 may also be disposed in the metal cavity 210. Refer to a structure shown in FIG. 6. Details are not described herein again.

In specific implementation, in the power dividers shown in FIG. 3 to FIG. 6, a width of the metal strip line 300 between the power division node A and the first node B may be the same as a width of the metal strip line 300 between the power division node A and the second node C, and the width of the metal strip line 300 between the first node B and the first output port 302 may also be the same as the width of the metal strip line 300 between the second node C and the second output port 303, to reduce processing complexity of the power divider. The width of the metal strip line 300 between the power division node A and the first node B may alternatively be different from the width of the metal strip line 300 between the power division node A and the second node C, and the width of the metal strip line 300 between the first node B and the first output port 302 may alternatively be different from the width of the metal strip line 300 between the second node C and the second output port 303, as long as it is ensured that areas with different widths exist on the first output line and the second output line, to form discontinuity nodes. In addition, in the power dividers shown in FIG. 3 to FIG. 6, the length of the metal strip line 300 between the power division node A and the first node B is less than the length of a metal strip line 300 between the power division node A and the second node C, or the length of the metal strip line 300 between the power division node A and the first node B may be greater than the length of the metal strip line 300 between the power division node A and the second node C, as long as it is ensured that the difference between the length of the metal strip line 300 between the power division node A and the first node B and the length of the metal strip line 300 between the power division node A and the second node C is an integer multiple of a quarter of the wavelength.

The first node B and the second node C are formed because of different widths of the metal strip line 300. The first node B and the second node C may also be formed because of discontinuous interfaces formed between the metal strip line 300 and the first dielectric. Refer to a structure shown in FIG. 7.

The power divider may include a first dielectric 400. The first dielectric 400 may be disposed between the metal ground plane 200 and the metal strip line 300. Along a structure of the metal strip line 300, that is, along the signal transmission direction on the metal strip line 300, parts of areas of the two output lines of the metal strip line 300 may be disposed on the first dielectric 400, and parts of areas may not be disposed on the first dielectric 400.

For example, the first dielectric 400 may be strip-shaped, the first output line (the arm on which the first output port is located) may be in a polyline shape, a part of an area of the first output line may be carried on the first dielectric 400, and a part of the area may not be carried on the first dielectric 400. The first node B may be an intersection point between the area of the first output line in contact with the first dielectric 400 and the area not in contact with the first dielectric 400. Because one of segments of the metal strip line 300 on two sides of the first node B is carried on the first dielectric 400, and the other is not carried on the first dielectric 400, the impedances of the metal strip line 300 on two sides of the first node B may be different.

Similar to a structure of the first output line, the second output line may also be in a polyline shape. One of segments of the metal strip line 300 on two sides of the second node C is carried on the first dielectric 400, and the other is not carried on the first dielectric 400, so that the impedances of the second output line on two sides of the second node C may also be different.

The difference between the length of the metal strip line 300 between the power division node A and the first node B and the length of the metal strip line 300 between the power division node A and the second node C may be an integer multiple of a quarter of the operating wavelength. For the metal strip line 300 shown in FIG. 7, the first output line includes a bending point D, a segment from the power division node A to the bending point D may be a straight line segment, and a segment from the bending point D to the first node B may also be a straight line segment. A length of the metal strip line 300 between the power division node A and the first node B may be a sum of a length of the metal strip line 300 between the power division node A and the bending point D and a length of the metal strip line 300 between the bending point D and the first node B. Similarly, a length of the metal strip line 300 between the power division node A and the second node C may be a sum of a length of the metal strip line 300 between the power division node A and a bending point E and a length of the metal strip line 300 between the bending point E and the second node C.

In this example, the first dielectric 400 may move relative to the metal strip line 300 and the metal ground plane 200 in a direction of a line connecting the first node B and the second node C. That is, the first dielectric 400 may move in the y-axis direction shown in the figure. When the first dielectric 400 moves in the direction of the line connecting the first node B and the second node C, a position of the first dielectric 400 relative to the metal ground plane 200 and the metal strip line 300 may change. Therefore, a distribution status of an electromagnetic field around the metal strip line 300 can be changed, to implement a phase adjustment function of the power divider. When the first dielectric 400 moves relative to the metal strip line 300, the metal strip line 300 on one side of the first node B may still be carried on the first dielectric 400, and the metal strip line 300 on the other side of the first node B may still not be in contact with the first dielectric 400. Similarly, the metal strip line 300 on one side of the second node C may still be carried on the first dielectric 400, and the metal strip line 300 on the other side of the second node C may still not be in contact with the first dielectric 400. In addition, positions of the first node B and the second node C may not change.

Alternatively, the metal strip line 300 may not be a straight line structure shown in the figure, for example, may include both a straight line segment and an arc segment. The length between the power division node A and the first node B may be a sum of a corresponding circumference of the arc segment and a length of the straight line segment. The length of the metal strip line 300 between the power division node A and the second node C is similar to this, and details are not described herein again.

FIG. 8 is a side view of a structure when the metal strip line 300 and the first dielectric 400 shown in FIG. 7 are disposed in the metal cavity 210. Similar to the structures described in FIG. 4 and FIG. 6, when the power divider includes the metal cavity 210, the power divider may include two layers of metal ground planes, that is, two layers of ground plane layers 211, which are respectively disposed on upper and lower sides of the metal strip line 300. Correspondingly, the power divider may also include two layers of first dielectrics 400, which are respectively disposed between the metal strip line 300 and an upper ground plane layer 211 and between the metal strip line 300 and a lower ground plane layer 211. Projections of the two layers of first dielectrics 400 in a direction perpendicular to a main plane of the first dielectrics 400 may overlap. That is, discontinuity nodes may be formed between the metal strip line 300 and the two layers of first dielectrics 400, and positions of the discontinuity nodes formed between the metal strip line 300 and the two layers of first dielectrics 400 may correspond to each other, to jointly form the first node B and the second node C.

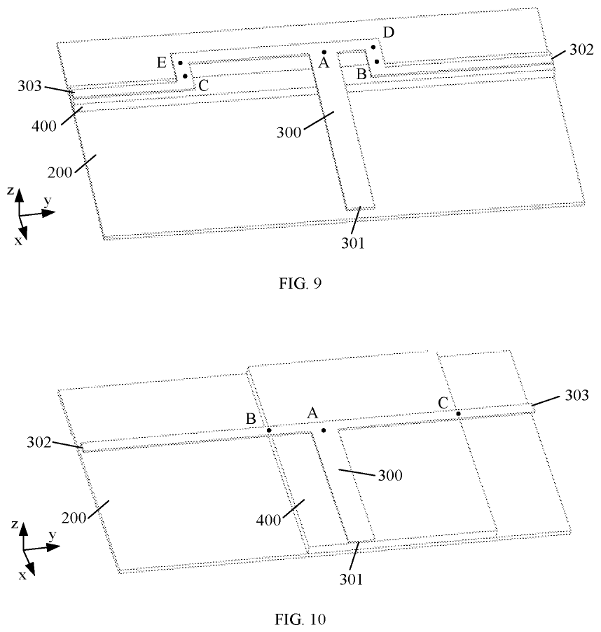

Output lines of the metal strip line 300 shown in FIG. 7 and FIG. 8 form a concave structure, and output lines of the metal strip line 300 shown in FIG. 9 form a convex structure. Similar to the structures of the metal strip line 300 shown in FIG. 7 and FIG. 8, a projection of the metal strip line 300 in FIG. 9, in the direction perpendicular to the main plane of the first dielectric 400, in a plane in which the first dielectric 400 is located is at least partially located outside an area in which the first dielectric 400 is located. The first node B may be an intersection point between an area of the first output line in contact with the first dielectric 400 and an area not in contact with the first dielectric 400. The second node C may be an intersection point between an area of the second output line in contact with the first dielectric 400 and an area not in contact with the first dielectric 400. A difference between a length of the metal strip line 300 between the power division node A and the first node B and a length of the metal strip line 300 between the power division node A and the second node C may be an integer multiple of a quarter of the operating wavelength.

According to the power divider described in FIG. 7 to FIG. 9, the first dielectric 400 is in a strip structure, an output line of the metal strip line 300 is in a polyline structure, an area in contact with the first dielectric 400 and an area not in contact with the first dielectric 400 exist on the polyline output line, and an intersection point is formed between the two areas. FIG. 10 shows another power divider according to an embodiment of this application. The first dielectric 400 is in a plate structure, and an output line of the metal strip line 300 is in a straight-line structure. In other words, the metal strip line 300 may be in a T-shaped structure. An area in contact with the first dielectric 400 and an area not in contact with the first dielectric 400 exist on the straight-line output line, and an intersection point is formed between the two areas.

Similar to FIG. 7 and FIG. 8, in the power divider shown in FIG. 9, the first dielectric 400 may also move relative to the metal strip line 300 in the y-axis direction shown in the figure, to perform phase adjustment. In addition, when the first dielectric 400 moves relative to the metal strip line 300, the metal strip line 300 on one side of the first node B may still be carried on the first dielectric 400, and the metal strip line 300 on the other side of the first node B may still not be in contact with the first dielectric 400. Similarly, the metal strip line 300 on one side of the second node C may still be carried on the first dielectric 400, and the metal strip line 300 on the other side of the second node C may still not be in contact with the first dielectric 400. In addition, positions of the first node B and the second node C may not change.

As shown in FIG. 10, the first dielectric 400 may be in the plate structure, and an input line of the metal strip line 300 may be disposed on the first dielectric 400. The input line is a part of the metal strip line 300 from the input port to the power division node A. For the first output line, a part between the power division node A and the first node B may be disposed on the first dielectric 400, and is in contact with the first dielectric 400, and a part between the first node B and the first output port 302 may not be disposed on the first dielectric 400. For the second output line, a part between the power division node A and the second node C may be disposed on the first dielectric 400, and is in contact with the first dielectric 400, and a part between the second node C and the second output port 303 may not be disposed on the first dielectric 400. Similar to the foregoing power divider, a difference between a length of the metal strip line 300 between the power division node A and the first node B and a length of the metal strip line 300 between the power division node A and the second node C may be an integer multiple of a quarter of the operating wavelength.

For the power divider shown in FIG. 10, there may also be two first dielectrics 400, which are respectively disposed in areas on two sides of the metal ground plane in FIG. 10, that is, areas in which the first dielectric 400 is not disposed on the metal ground plane in FIG. 10. The first dielectric 400 may not be disposed in an area in which the first dielectric 400 is disposed in FIG. 10. In this way, the metal strip line 300 between the first node B and the first output port 302 may be carried on the first dielectric 400 and in contact with the first dielectric 400, and the metal strip line 300 between the second node C and the second output port 303 may also be carried on the first dielectric 400 and in contact with the first dielectric 400. The metal strip line 300 between the first node B and the second node C is not disposed on the first dielectric 400, and is not in contact with the first dielectric 400.

In the power dividers described in FIG. 3 to FIG. 10, the first dielectric 400 is in a uniform structure. In other words, thicknesses in all positions of the first dielectric 400 may be the same. The first dielectric 400 may alternatively be in a non-uniform structure.

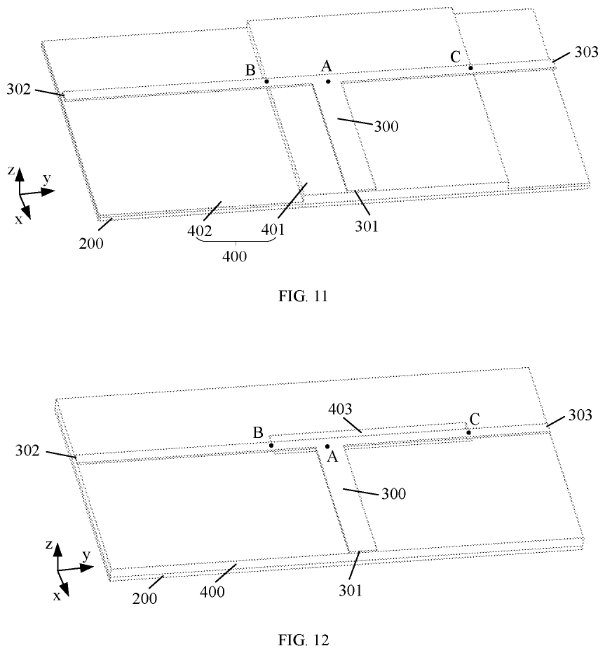

For example, refer to a structure shown in FIG. 11. The first dielectric 400 may include a first area 401 and a second area 402. A thickness of the first area 401 may be greater than a thickness of the second area 402. That is, a size of the first area 401 in the direction perpendicular to the metal ground plane 200 is greater than a size of the second area 402 in the direction perpendicular to the metal ground plane 200. At least parts of the first output line and the second output line may be carried on the first area 401. In the first output line, the metal strip line on one side of the first node B may be carried on the first area 401, and a gap may exist between the metal strip line 300 on the other side of the first node B and the second area 402. For example, the metal strip line 300 between the power division node A and the first node B may be carried on the first area 401. The metal strip line 300 between the first node B and the first output port 302 may be located above the second area 402 in the z-axis direction shown in the figure, and a gap may exist between the metal strip line 300 and the second area 402. Similarly, in the second output line, the metal strip line 300 on one side of the second node C is carried on the first area 401, and a gap may exist between the metal strip line 300 on the other side of the second node C and the second area 402. For example, the metal strip line 300 between the power division node A and the second node C may be carried on the first area 401. The metal strip line 300 between the second node C and the second output port 303 may be located above the second area 402 in the z-axis direction shown in the figure, and a gap may exist between the metal strip line 300 and the second area 402.

In another example, refer to a structure shown in FIG. 12. The first dielectric 400 may include a first recess 403. The first recess 403 may penetrate the first dielectric 400 in the direction perpendicular to the first dielectric 400, that is, penetrate the first dielectric 400 in the z-axis direction, or may not penetrate the first dielectric 400. The metal strip line 300 may be in a “T”-shaped structure, and the first output line may be at least partially disposed above the first recess 403. That is, the metal strip line 300 on one side of the first node B may be carried on the first dielectric 400, and the metal strip line 300 on the other side may be located above the first recess 403, that is, not in contact with the first dielectric 400. Similarly, the metal strip line 300 on one side of the second node C may be carried on the first dielectric 400, and the metal strip line 300 on the other side is located above the first recess 403. The metal strip line 300 shown in the figure is in contact with short sides of the first recess 403, and projections of the first node B and the second node C in the direction perpendicular to the metal ground plane 200 are located on the short sides of the first recess 403. The metal strip line 300 may alternatively be in contact with long sides of the first recess 403, and projections of the first node B and the second node C in the direction perpendicular to the metal ground plane 200 may be located on the long sides of the first recess 403. In addition, a difference between a length of the metal strip line between the power division node A and the first node B and a length of the metal strip line between the power division node A and the second node C may be an integer multiple of a quarter of the operating wavelength. For example, when the metal strip line 300 is of a polyline structure shown in FIG. 7 or FIG. 9, the two output lines of the metal strip line 300 may include a bending part, and the bending part may be in contact with a long side of the first recess 403.

Widths of the first output line and the second output line shown in FIG. 12 are less than a width of the first recess 403, and the widths of the first output line and the second output line may alternatively be greater than the width of the first recess 403. This is not limited in this application. For the power divider shown in FIG. 12, widths of the first output line, the second output line, and the first recess 403 are sizes of the first output line, the second output line, and the first recess 403 in the x-axis direction shown in the figure. A cross section shape of the first recess 403 along the xy plane may be a rectangle shown in the figure, or may be a square, a circle, an ellipse, an irregular shape, or the like. This is not limited in this application.

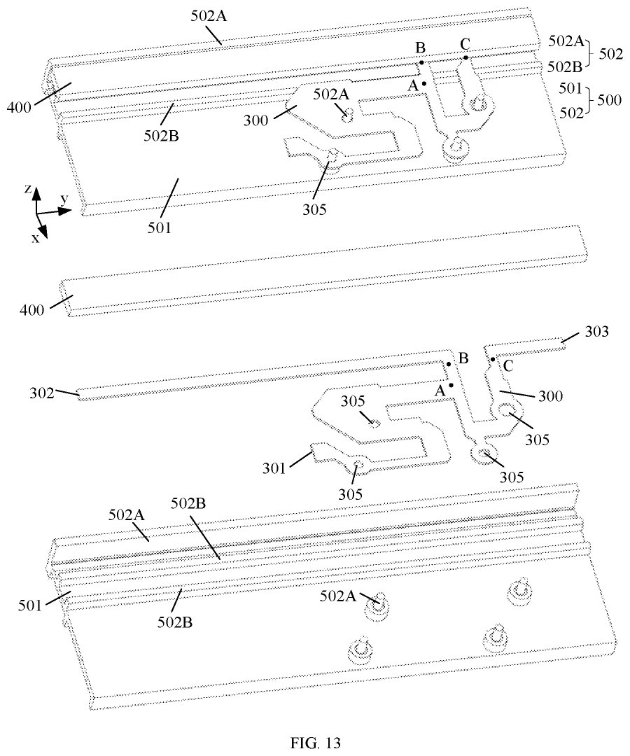

In some embodiments, the power divider may further include a second dielectric 500. The second dielectric 500 may be connected to the metal ground plane 200, and the second dielectric 500 may be configured to support the metal strip line 300. The second dielectric 500 may also be a non-metal material, and a material of the second dielectric 500 may be the same as or different from the material of the first dielectric 400. For example, refer to a structure shown in FIG. 13 (to ease of displaying a structure of the second dielectric 500, the metal ground plane 200 is omitted in FIG. 13, and the metal ground plane 200 may be disposed below the second dielectric 500, or may be disposed above the first dielectric 400, or may be disposed below the second dielectric 500 and above the first dielectric 400). The metal strip line 300 may be in an irregular structure, and the second dielectric 500 may include a first part 501 and a second part 502. The first part 501 may be in a plate structure, and a main plane of the first part 501 may be the xy plane shown in the figure. The main plane of the first part 501 is a plane with a large plane area of the first part 501. The first part 501 may be disposed below the metal strip line 300. The second part 502 may be fastened to the first part 501, and may extend in a direction perpendicular to the main plane of the first part 501. The second part 502 may be disposed below the metal strip line 300 (for example, a part 502B shown in the figure), or may extend from below the metal strip line 300 to above the metal strip line 300 (for example, a part 502A shown in the figure). In an example in which the part 502A extends from below the metal strip line 300 to above the metal strip line 300, the metal strip line 300 may include one or more through holes 305, and the 502A part may pass through the through hole 305 and extend from below the metal strip line 300 to above the metal strip line 300. The part 502A may alternatively be located at an edge of the second dielectric 500, and extend from an area in which the metal strip line 300 is located to an area above the metal strip line 300.

Similar to the second dielectric 500, the metal ground plane 200 may also include an extension part (not shown in the figure), and the metal ground plane 200 may be fastened to the second dielectric 500 through the extension part. For example, when the metal ground plane 200 is located below the second dielectric 500, the metal strip line 300 may be disposed above the second dielectric 500, as shown in FIG. 13, that is, may be disposed above a surface that is of the second dielectric 500 and that is away from the metal ground plane 200. Alternatively, the metal strip line 300 may be disposed on a surface that is of the second dielectric 500 and that is close to the metal ground plane 200, that is, located below the second dielectric 500, and located between the second dielectric 500 and the metal ground plane 200. When the metal strip line 300 is disposed on the surface that is of the second dielectric 500 and that is close to the metal ground plane 200, a gap may exist between the metal strip line 300 and the metal ground plane 200.

The first dielectric 400 may be disposed above the metal strip line 300. The metal strip line 300 on one side of the first node B may be in contact with the first dielectric 400, and the metal strip line 300 on the other side may not be in contact with the first dielectric 400. The metal strip line 300 on one side of the second node C may be in contact with the first dielectric 400, and the metal strip line 300 on the other side may not be in contact with the first dielectric 400. In addition, the metal strip line 300 between the power division node A and the first node B and the metal strip line 300 between the power division node A and the second node C satisfy the foregoing length difference requirement. The first dielectric 400 may alternatively be disposed below the metal strip line 300, that is, may be disposed between the metal strip line 300 and the second dielectric 500.

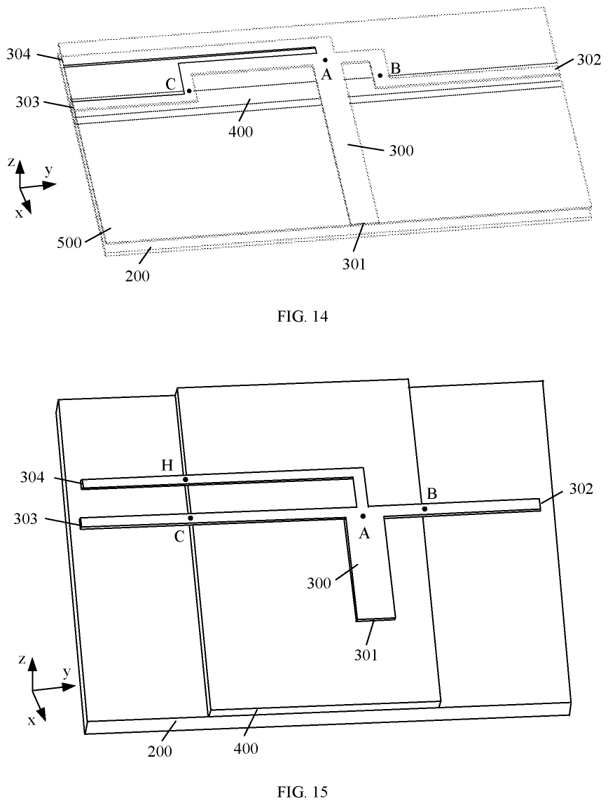

The power divider described in FIG. 3 to FIG. 13 each includes two output ports, and the power divider may alternatively include three or more output ports. For example, in a structure described in FIG. 14, the power divider may further include a third output port 304, and a part of the metal strip line 300 from the power division node to the third output port 304 may be referred to as a third output line. Similarly, according to a reciprocity principle, three output ports may be used as three input ports, and the input port may be used as an output port. When the power divider includes three output lines, any two of the output lines may include discontinuity nodes and satisfy the length difference requirement for the metal strip line. For example, the first output line and the second output line respectively include the first node B and the second node C, and a difference between a length of the metal strip line 300 between the power division node A and the first node B and a length of the metal strip line 300 between the power division node A and the second node C is an integer multiple of a quarter of the operating wavelength. Impedances of points on the third output line may be the same. That is, the third output line may not be in contact with the first dielectric.

Alternatively, the first output line and the third output line may respectively include the first node B and a third node, and a difference between a length of the metal strip line 300 between the power division node A and the first node B and a length of the metal strip line 300 between the power division node A and the third node is an integer multiple of a quarter of the operating wavelength. Alternatively, the second output line and the third output line may respectively include a second node C and a third node, and a difference between a length of the metal strip line 300 between the power division node A and the second node C and a length of the metal strip line 300 between the power division node and the third node is an integer multiple of a quarter of the operating wavelength (the third node is not shown in FIG. 14).

The power divider shown in FIG. 14 may also include a second dielectric 500. The second dielectric 500 in FIG. 14 is disposed between the metal strip line 300 and the first dielectric 400 as an example. A structure of the second dielectric 500 may also be similar to the structure of the second dielectric 500 in FIG. 13, and details are not described herein again.

In some embodiments, all the three output lines may alternatively include discontinuity nodes. As shown in FIG. 15, the third output line may include a third node H. A difference between a length of the metal strip line between the power division node A and the third node H and a length of the metal strip line between the power division node A and the first node B may be an integer multiple of a quarter of the operating wavelength, or a difference between the length of the metal strip line between the power division node A and the third node H and a length of the metal strip line between the power division node A and the second node C may be an integer multiple of a quarter of the operating wavelength.

For example, in the power divider shown in FIG. 15, the length of the metal strip line 300 between the power division node A and the third node H is greater than the length of the metal strip line 300 between the power division node A and the second node C, and the difference between the length of the metal strip line 300 between the power division node A and the third node H and the length of the metal strip line 300 between the power division node A and the second node C may be an integer multiple of a quarter of the operating wavelength. A difference between the length of the metal strip line 300 between the power division node A and the second node C and the length of the metal strip line 300 between the power division node A and the first node B may be an integer multiple of a quarter of the operating wavelength, or may not be an integer multiple of a quarter of the operating wavelength.

For another example, the difference between the length of the metal strip line between the power division node A and the first node B and the length of the metal strip line between the power division node A and the second node C may be an integer multiple of a quarter of the operating wavelength. The length of the metal strip line 300 between the power division node A and the third node H may be the same as the length of the metal strip line 300 between the power division node A and the first node B (not shown in the figure), so that the difference between the length of the metal strip line between the power division node A and the third node H and the length of the metal strip line between the power division node A and the second node C is an integer multiple of a quarter of the operating wavelength. Similarly, the length of the metal strip line 300 between the power division node A and the third node may also be the same as the length of the metal strip line 300 between the power division node A and the second node C, and the difference between the length of the metal strip line between the power division node A and the third node H and the length of the metal strip line between the power division node A and the first node B is an integer multiple of a quarter of the operating wavelength.

FIG. 14 and FIG. 15 use an example in which the power divider includes three output ports to describe a discontinuity node setting situation on each output line when a plurality of output ports are used. Similarly, when the power divider includes more than three output ports, any two output lines may include discontinuity nodes, and the nodes satisfy the foregoing length difference requirement for the metal strip line. Alternatively, each output line may include a discontinuity node, and each two of the discontinuity nodes on the output lines may satisfy the length difference requirement for a metal strip line of a quarter of the operating wavelength, to implement standing wave cancellation.

FIG. 14 and FIG. 15 use an example in which distribution of the first dielectric 400 on the output lines of the metal strip line 300 changes, to describe a setting manner of discontinuity nodes when the power divider includes three output ports. Similarly, the metal strip line 300 includes three or more output ports, and discontinuity nodes may alternatively be formed on the output lines by setting different widths on the output lines. A length difference relationship for the metal strip line that is satisfied by nodes at which widths change discontinuously on the output lines may be similar to that of the discontinuity nodes formed by the metal strip line 300 and the first dielectric. To avoid repetition, details are not described herein again.

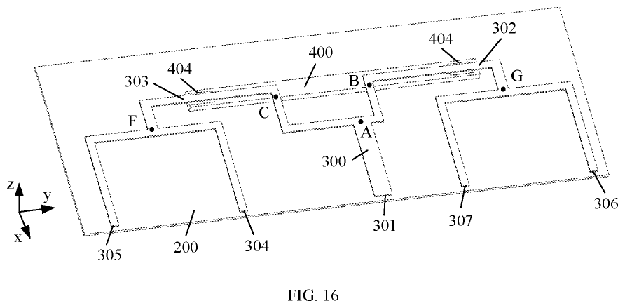

The power divider described in FIG. 3 to FIG. 13 may be a one-to-two power divider, the power divider described in FIG. 14 and FIG. 15 is a one-to-three power divider, and the power divider described in FIG. 16 is a one-to-four power divider. The one-to-four power divider may include a first power division part and a second power division part. For example, cabling may be continued on the basis of the one-to-two power divider structures shown in FIG. 3 to FIG. 13, and a one-to-two power divider is connected to each of the first output port and the second output port. The first output port may be connected to the first power division part, and the first output port may be used as an input port of the first power division part. A signal of the power divider may flow into the first power division part through the first output port, is divided into two at a power division node F of the first power division part, and is transmitted to output ports 304 and 305 of the first power division part. The second output port may be connected to the second power division part, and the second output port may be used as an input port of the second power division part. After a signal of the power divider flows into the second power division part through the second output port, the signal is divided into two at a power division node G of the second power division part, and is transmitted to output ports 306 and 307 of the second power division part. Impedances in all positions of the first power division part may be the same. For example, the entirety of the first power division part may not be disposed on the first dielectric, or the entirety of the first power division part may be disposed on the first dielectric. The entirety of the first power division part may be a part between the first output port 302 and the ports 304 and 305 of the first power division part. Similarly, impedances in all positions of the second power division part may be the same. For example, the entirety of the second power division part may not be disposed on the first dielectric, or the entirety of the second power division part may be disposed on the first dielectric, provided that parts of the first output line and the second output line of the power divider have nodes at which impedances change discontinuously, and a metal strip line between the nodes satisfies the foregoing difference requirement. A node at which impedances change discontinuously may alternatively be provided on the first power division part. For example, the first power division part may be partially carried on the first dielectric, or areas with different widths exist on the first power division part. The discontinuity node on the first power division part may be provided on an arm on which the port 304 is located, or may be provided on an arm on which the port 305 is located, or nodes at which impedances change discontinuously may be provided on both the arms on which the port 304 and the port 305 are located. Similarly, a node at which impedances change discontinuously may also be provided on the second power division part. This is not limited in this application.

The first dielectric 400 of the power divider may further include a second recess 404. The second recess may be disposed at an end of the first dielectric 400, and an output line may be at least partially disposed above the second recess 404. For example, when the power divider includes two output lines, there may be two second recesses 404, which are respectively provided at two ends of the first dielectric 400. Providing the second recesses 404 can implement impedance matching between the first output line and the second output line.

It should be noted that the power divider shown in FIG. 16 may include only the first power division part or only the second power division part. The first power division part and the second power division part may alternatively be a one-to-three or one-to-many power divider, provided that discontinuity nodes exist on two output lines corresponding to a power division part in which a signal initially flows on the entire power divider, and a length of the metal strip line between the nodes satisfies the foregoing difference requirement. When the power divider includes the first power division part and/or the second power division part, the discontinuity node may also be formed because of discontinuous widths on the metal strip line 300.

In the embodiments described in FIG. 3 to FIG. 16, each output line includes only one discontinuity node, and each output line may alternatively include a plurality of discontinuity nodes, provided that a length of the metal strip line between a discontinuity node on each of the two output lines and the power division node satisfies the length difference requirement. In addition, a discontinuity node on each output line of the power divider is formed because of discontinuous width changes of the metal strip line, or is formed by discontinuous distribution of the first dielectric in the signal transmission direction of the metal strip line. The discontinuity node on the output line may alternatively include the foregoing two forms (not shown in the figure). For example, in the first output line, widths of the metal strip line 300 on two sides of the first node B are different, and in the second output line, the metal strip line 300 on one side of the second node C is carried on the first dielectric 400, and the metal strip line 300 on the other side is not in contact with the first dielectric 400. For another example, in the first output line, widths of the metal strip line 300 on two sides of the first node B are different, the metal strip line 300 on one side of the first node B is carried on the first dielectric 400, and the metal strip line 300 on the other side is not in contact with the first dielectric 400. The second output line may be similar to the foregoing. In other words, a discontinuity node formed between a part of the metal strip line 300 that is in contact with the first dielectric 400 and a part that is not in contact with the first dielectric 400 and a discontinuity node formed because of different widths of the metal strip line 300 may be a same node. The discontinuity node formed between the part of the metal strip line 300 in contact with the first dielectric 400 and the part not in contact with the first dielectric 400 may alternatively be different from the discontinuity node formed because of different widths of the metal strip line 300, provided that one of the discontinuity nodes on the first output line and one of the discontinuity nodes on the second output line satisfy the foregoing distance difference relationship.

The metal strip line in this embodiment of this application may be a PCB structure, or may be a sheet metal strip line fastened by a plastic dielectric. This is not limited in this application. The power divider may be an independent power divider, or may be a part of a feed network.

An embodiment of this application further provides a feed network. The feed network includes any power divider described in the foregoing embodiments.

An embodiment of this application further provides an antenna system. The antenna system includes the feed network and one or more antenna elements. A plurality of antenna elements may also be arranged in an antenna array.

An embodiment of this application further provides a base station. The base station may include the foregoing antenna system and one or more radio frequency modules. The antenna system may be connected to the radio frequency module.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A power divider, used in an antenna system, comprising:
a metal ground plane; and
a metal strip line, wherein the metal strip line is disposed on a side of the metal ground plane in a direction perpendicular to the metal ground plane, the metal strip line comprises a power division node, an input port, a first output port, and a second output port, and the power division node is configured to separately transmit, to the first output port and the second output port, a signal input from the input port, wherein:
the metal strip line between the power division node and the first output port is a first output line, the first output line comprises a first node, and impedances of the metal strip line on two sides of the first node are different;
the metal strip line between the power division node and the second output port is a second output line, the second output line comprises a second node, and impedances of the metal strip line on two sides of the second node are different; and
a difference between a length of the metal strip line between the power division node and the first node and a length of the metal strip line between the power division node and the second node is an integer multiple of a quarter of an operating wavelength of the antenna system.

2. The power divider according to claim 1, wherein at least one of:
widths of the metal strip line on two sides of the first node are different; or
widths of the metal strip line on two sides of the second node are different.

3. The power divider according to claim 2, wherein:
a width of the metal strip line between the first node and the second node is greater than both a width of the metal strip line between the first node and the first output port and a width of the metal strip line between the second node and the second output port; or
the width of the metal strip line between the first node and the second node is less than both the width of the metal strip line between the first node and the first output port and the width of the metal strip line between the second node and the second output port.

4. The power divider according to claim 1, wherein the power divider further comprises a first dielectric, the first dielectric is at least partially disposed between the metal strip line and the metal ground plane, and the metal strip line is at least partially carried on the first dielectric.

5. The power divider according to claim 4, wherein at least one of:
in the first output line, the metal strip line on one side of the first node is carried on the first dielectric, and the metal strip line on the other side of the first node is not carried on the first dielectric; or
in the second output line, the metal strip line on one side of the second node is carried on the first dielectric, and the metal strip line on the other side of the second node is not carried on the first dielectric.

6. The power divider according to claim 4, wherein the first dielectric is strip-shaped, and the first dielectric is movable in a direction connecting the first node and the second node.

7. The power divider according to claim 4, wherein the first dielectric comprises a first recess, and wherein at least one of:
in the first output line, the metal strip line on one side of the first node is carried on the first dielectric, and the metal strip line on the other side of the first node is disposed above the first recess; or
in the second output line, the metal strip line on one side of the second node is carried on the first dielectric, and the metal strip line on the other side of the second node is located above the first recess.

8. The power divider according to claim 4, wherein at least one of:
the first dielectric comprises a first area and a second area, and a size of the first area in the direction perpendicular to the metal ground plane is greater than a size of the second area in the direction perpendicular to the metal ground plane;
in the first output line, the metal strip line on one side of the first node is carried on the first area, and a gap exists between the metal strip line on the other side of the first node and the second area; or
in the second output line, the metal strip line on one side of the second node is carried on the first area, and a gap exists between the metal strip line on the other side of the second node and the second area.

9. The power divider according to claim 4, wherein the power divider comprises a metal cavity, the metal cavity encloses accommodation space, the metal strip line and the first dielectric are disposed in the accommodation space, and the metal ground plane is a part that is of the metal cavity and that is stacked with the metal strip line.

10. The power divider according to claim 4, wherein there are at least two first dielectrics, and the at least two first dielectrics are respectively disposed on two sides of the metal strip line in a direction perpendicular to the metal strip line.

11. The power divider according to claim 1, wherein the power divider further comprises a third output port, the metal strip line between the power division node and the third output port is a third output line, and impedances of points on the third output line are the same.

12. The power divider according to claim 4, wherein the power divider further comprises a third output port, the metal strip line between the power division node and the third output port is a third output line, the third output line comprises a third node, and impedances of the metal strip line on two sides of the third node are different, and wherein:
a difference between a length of the metal strip line between the power division node and the third node and the length of the metal strip line between the power division node and the first node is an integer multiple of a quarter of the operating wavelength of the antenna system; or
a difference between the length of the metal strip line between the power division node and the third node and the length of the metal strip line between the power division node and the second node is an integer multiple of a quarter of the operating wavelength of the antenna system.

13. The power divider according to claim 12, wherein in the third output line, the metal strip line on one side of the third node is carried on the first dielectric, and the metal strip line on the other side of the third node is not carried on the first dielectric.

14. The power divider according to claim 12, wherein widths of the metal strip line on two sides of the third node are different.

15. The power divider according to claim 1, wherein the power divider further comprises at least one of a first power division part or a second power division part, the first power division part is connected to the first output port, the first output port is an input port of the first power division part, the second power division part is connected to the second output port, and the second output port is an input port of the second power division part.

16. The power divider according to claim 15, wherein at least one of:
impedances in all positions of the first power division part are the same; or
impedances in all positions of the second power division part are the same.

17. The power divider according to claim 1, wherein the metal strip line is a printed circuit board structure, or the metal strip line is a sheet metal strip line fastened by a plastic dielectric.

18. An antenna system, comprising a feed network and one or more antenna elements connected to the feed network, wherein the feed network comprises:
a metal ground plane; and
a metal strip line, wherein the metal strip line is disposed on a side of the metal ground plane in a direction perpendicular to the metal ground plane, the metal strip line comprises a power division node, an input port, a first output port, and a second output port, and the power division node is configured to separately transmit, to the first output port and the second output port, a signal input from the input port, wherein:
the metal strip line between the power division node and the first output port is a first output line, the first output line comprises a first node, and impedances of the metal strip line on two sides of the first node are different;
the metal strip line between the power division node and the second output port is a second output line, the second output line comprises a second node, and impedances of the metal strip line on two sides of the second node are different; and
a difference between a length of the metal strip line between the power division node and the first node and a length of the metal strip line between the power division node and the second node is an integer multiple of a quarter of an operating wavelength of the antenna system.

19. The antenna system according to claim 18, wherein at least one of:
widths of the metal strip line on two sides of the first node are different; or
widths of the metal strip line on two sides of the second node are different.

20. The antenna system according to claim 19, wherein:
a width of the metal strip line between the first node and the second node is greater than both a width of the metal strip line between the first node and the first output port and a width of the metal strip line between the second node and the second output port; or
the width of the metal strip line between the first node and the second node is less than both the width of the metal strip line between the first node and the first output port and the width of the metal strip line between the second node and the second output port.
